(19) United States
(12) Patent Application Publication
(10) Pub. No.: US 2010/0140915 A1
(43) Pub. Date: Jun. 10, 2010

(54) WRITING PAPER

(76) Inventor: Olof Hansson, Stockholm (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 12/703,606

(22) Filed: Feb. 10, 2010

Related U.S. Application Data
(63) Continuation-in-part of application No. 11/911,113, filed on Oct. 10, 2007, now abandoned.

(30) Foreign Application Priority Data
Apr. 13, 2005 (SE) 0500825-5

(51) Int. Cl. G09B 11/00

(52) U.S. Cl. 283/45

(57) ABSTRACT

The writing paper with lines has a paper area with one or many reading or writing lines wherein the paper has a main area with a first degree of color difference and one or many lines with a second degree of color difference, that visibly contrast the degree of color difference of the main area, characterized therein that the lines have a lower degree of color difference than the main area. The degree of color difference between the lines and the background area, defined as delta E in (CIE)-Lab space, is in the interval 1-18, preferably 2-10.

### PRIOR APPLICATION

This is a continuation-in-part patent application claiming priority from U.S. patent application Ser. No. 11/911,113, filed 10 Oct. 2007 that claims priority from PCT/US06/13061, filed 7 Apr. 2006 and Swedish patent application 0500825-5, filed 13 Apr. 2005.

### TECHNICAL FIELD

The invention relates to a writing paper that includes reading or writing lines.

### BACKGROUND AND SUMMARY OF THE INVENTION

In particular, when handwritten notes are to be written on a paper sheet, it is desirable that the sheet is provided with parallel horizontal lines and possibly also vertical parallel lines to form a grid pattern such as a pattern with squares. Even when reading, it is desirable that the sheet has such lines.

When copying writings and pictures onto a paper it is often less desirable that the lines are visible on the copy. On the other hand, it is desirable that the lines clearly contrast the background of the lines that are formed on the sheet surface so that the lines provide an effective support for the writer during reading and writing. On conventionally lined substantially white paper with dark lines the lines often copy better onto the copies than the notes when using conventional office copiers and scanners.

If one tries to make the lines lightly colored, they do not fill their intended basic function i.e. to provide a support for keeping the writing on straight rows. To both provide easily visible lines and also to prevent the copying of these lines onto the copies during copying of the handwritten sheet, it is known to provide white paper sheets with relatively strong contrasting lines of a color (blue) that older conventional copiers have difficulties in recognizing. This has only a limited use since copiers and scanners nowadays also recognize colors including blue.

One object of the invention is therefore to provide a paper with lines that provide good reading ergonomics. The object is also to provide lines that are clear but still light so that they not easily can be transferred over to copies when using conventional copiers/scanners.

The object is accomplished by the invention.

### BRIEF DESCRIPTION OF THE DRAWINGS

FIG. 1 is a schematic view of the writing paper of the present invention;

FIG. 2 is a schematic view of a portion of the writing paper shown in FIG. 1; and

FIG. 3 is an illustration of the color difference between the supporting line, the background and the pen mark.

### DETAILED DESCRIPTION

The invention basically means that the lines of the paper sheet are formed by “un-colored” paper-surface portions while the rest of the paper surface has an evenly extending and very light “coloring.” The lines represent an insignificant part of the surface area of the paper sheet. The coloring is sufficiently light so that it is not recognized by the sensor devices of conventional copiers or scanners due to the contrast relative to the lines or relative to a reference. Because the light coloring extend over a relatively large area on the paper sheet, it can easily be recognized by the human eye as a peaceful and relaxing background while the un-colored paper areas are recognized as distinctly contrasting despite the insignificant color difference between the lines and the background i.e. the colored and the uncolored surfaces. Although the color difference between the lines is insignificant it is easily recognized by the human eye even when the lines have an insignificant color difference (uncolored or white), while a copier with a normally set sensitivity has difficulties in recognizing that the background surface has a contrasting color relative to the lines. The sensitivity limits of copiers/scanners are normally set to a value so that dirt etc. is not shown on the copy.

A white paper sheet in A4 format for typing was provided with square-shaped filled boxed with an edge length of 5 mm. The boxes were aligned in orthogonal rows and columns with a relative distance of 1 mm. The distance between the boxes thus defined a pattern of equidistant uncolored lines that were perpendicular to one another with a width of 1 mm. The difference between the light lines and the darker portions of the sheet, i.e. delta E, in Lab-space, is in the interval 1-18, preferably in the interval 2-10. In the lower part of the interval a conventional office copier and a conventional office scanner did not recognize any color or blackness of the boxes while the human eye could clearly recognize the lines.

The paper sheet of the present invention has substantially white lines on a paper surface wherein the remainder has a light color tone or gray tone (has a low color difference), the white lines are, in all places, recognized as more clear compared to the corresponding toned lines on the substantially white background. A drawn black line gets a clear contrasting effect on the paper of the present invention even though it is drawn on a substantially white line or on a toned background since the lines of the paper are white and the background tone of the paper have a very low color difference. In contrast hereto a drawn black line on a white paper with a toned line pattern is more difficult to recognize since the toned line on a white paper get a lower difference compared to the drawn black line compared to the toned background of the paper pattern of the present invention even when the color difference between the white paper surface and the toned part is the same in both cases.

According to the invention it seems important that the colored area is much larger than the uncolored area. For example, the uncolored lines should account for at the most 20% of the colored area.

Compared to conventional paper with dark lines on a white background the invention provides, for the human eye, a clearer contrast and more distinguished difference for a line with a substantial color difference that is drawn on the paper even if the drawn line is narrow. When copying of the paper of the invention with writings with colored lines, the writing is clearly copied while the toned background is not recognized by a conventional office copier/scanner.

Even black and white shall be seen as colors. “Paper” means a thin sheet material that is intended to be provided with a writing. A “paper sheet” does not have to include cellulose but be based on any material with which a thin sheet product can be made that is writable.

FIG. 1 shows a writing paper 100 of the present invention. The paper 100 has horizontal light-colored reading or writing supporting lines 102 and vertical light colored reading or writing supporting lines 104. Preferably, the lines 102 and 104 are substantially white or uncolored but the lines may include some very light color tones, as described below. The paper may only have either horizontal lines 102 and/or vertical lines 104. The paper 100 has a background 106 that has a color that is darker than the lines 102, 104 but closer to the white point than pen marks 108. The background 106 is preferably a solid color although FIG. 1 illustrates the background 106 as a plurality of diagonal lines to make it easier to copy the figures during the handling of this patent application.

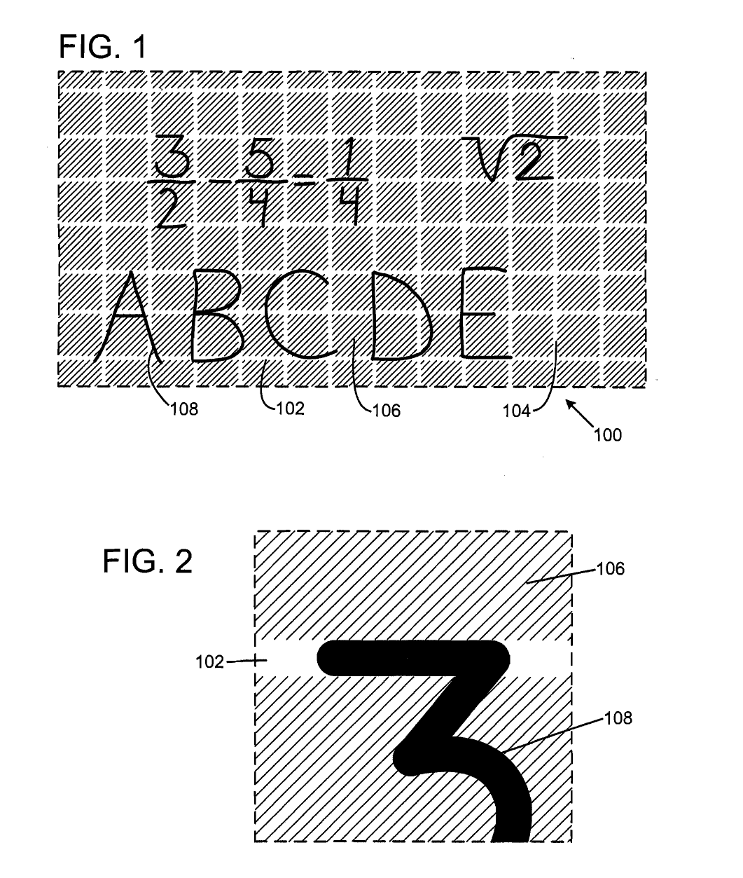

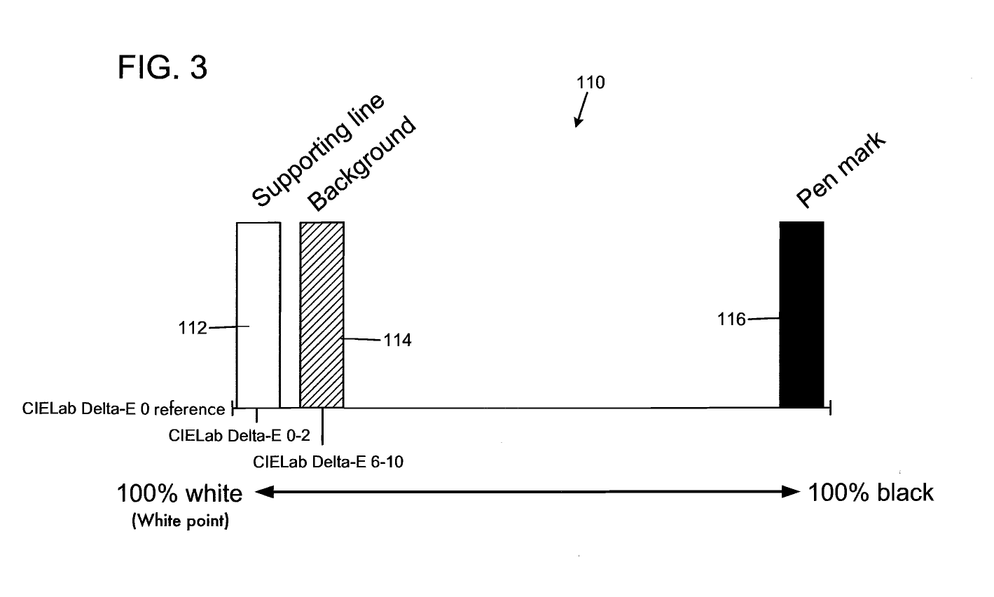

FIG. 2 shows a detailed view of a portion of FIG. 1 wherein the upper portion of the pen mark 108 i.e. the upper part of the digit 3, is printed on the horizontal line 102 so that the pen mark 108 clearly shows relative to the light or white color of the line 102 and the background 106. FIG. 3 illustrates a comparison chart 110 of the color difference between the supporting lines 102 that has a color tone 112 that is in a range of CIE-Lab Delta E 0-2 compared to a white color, the background 106 has a color tone 114 in a range of CIE-Lab Delta E 6-10 compared to the color tone of the supporting lines 102, 104. CIE-lab Delta E value of 1 is the limit of the perception of the human eye so that values below 1 represents color tone differences that the human eye cannot distinguish from, for example, a white color tone. The pen mark 108 has a color tone 116 that is very dark or almost black which is outside the typical CIE range i.e. at least CIE-Lab Delta E value of 18 or possibly higher.

As indicated above, the difference between the substantially white or uncolored reading or writing lines 102, 104 and the darker background portion 106 of the writing paper 100, i.e. delta E, in Lab-space, may be in the interval 1-18, preferably in the interval 2-10. More preferably, the interval is 4-8 and most preferred around 6.

The width of the writing lines 102 or vertical lines 104 may have a width of about 0.1-1.5 millimeters. Preferably, the width is about 0.2-1.0 millimeters. More preferably, the width is about 0.3-0.4 millimeters and most preferred the width is about 0.35 millimeters. Thicker and thinner lines may also be used.

Compared to conventional paper the writing paper of the present invention adds one new visual color tone level which clarifies reading for both humans and machines due to the fact that pens always produce dark lines. When using the present invention, i.e. when writing on the writing paper 100 with a pen, the only dark element on the paper is the pen markings. The present invention uses three color tone levels (see FIG. 3) which are represented by the supporting lines 102, 104 which are whiter than the background 106, the background which is whiter than the pen markings so that the pen markings 108 are always darker than both the background 106 and the supporting lines 102, 104. A conventional paper only uses two color tone levels where the dark elements which are represented by both the supporting lines and pen markings compete visually for both the human and machine. The present invention eliminates the risk of reading errors for both human reading and automatic reading by machines since the only dark lines on the writing paper of the present invention are the lines produced from a pen. For example, a minus sign can never be lost when written on the writing paper of the present invention as it can be when written on a dark line of a conventional paper.

The writing paper of the present invention uses both positive and negative polarity to separate the information from the supporting lines and the pen markings which both are graphical represented as lines. Positive polarity means a dark element on a light background. Negative polarity means light element on a dark background. On the writing paper of the present invention, the lines use negative polarity while the pen markings use, as always, positive polarity.

Positive polarity is for the human eye easier to perceive and get our attention than negative polarity which means that a dark supporting line heavily distracts the reader's reading as it gets our attention even though the reader does not want that to happen when the reader reads. The present invention substantially improves the ability to read written words for readers with visual perceptual impairment which may be found among readers with dyslexia.

The writing on a paper is an activity which takes substantially longer such as 5-10 times more time than to read the same sentence since the eyes move over the surface more rapidly when the reader reads compared to when the sentence is written on the paper. While reading is quicker than writing it is of greater interest to ease the reading to reduce the risk of reading errors which occurs when a written syllable or figure is not easy to understand from a hand writing that is not very clear. The present invention not only reduces the risk of reading errors coming from a dark line distracting our reading and intervening with the hand writing but also eliminates the risk since there are no dark elements on the paper except for the pen markings. This problem has existed as a problem for a long time through history without a good solution since dark lines to support writing have been used since medieval times.

With modern technology such as optical character recognition (OCR) it is possible to automatically convert handwritten documents and forms in to digital format.

Today's OCR-software suffers from the same difficulties as the human eye when interpreting characters interfered by dark supporting lines, this is due to the fact that both characters and dark lines are represented on the paper as positive polarity. The writing paper of the present invention solves that problem as the only positive polarity represented on the paper is the hand writing, i.e. the dark characters produced by the hand writing or pen markings.

Reading is improved for both humans and machines when one syllable is placed after the previous syllable in straight rows. The writing paper of the present invention helps the user write in straight rows and eliminates at the same reading errors from dark lines conflicting with the pen markings.

The writing paper 100 of the present invention provides a colored background 106 which reduces reflections from the paper. This reduces visual stress which is of great help for users who use writing paper for a long time and especially for people with Meares-Irlen syndrome.

In order to efficiently characterize the features that make the writing paper of the present invention unique the concept of color differences is used. The human color vision is dynamic and has a broad range from night vision to day vision. The ability to discern patterns in the range of active vision depends on the contrast between the pattern and its background. In the active range, persons with normal color vision can observe patterns if the contrast is large enough. The contrast is expressed in a unit called delta-E. For a person having normal vision the limit to discern color differences, the just noticeable difference (JND), has been set as a reference with the value delta-E equal to one. Delta-E describes color differences in a system called the standard observer system of CIE (Comite International d'Eclairage). CIE was established in the 1930's for industries such as the Graphic Arts Industry. As indicated above, the color difference of 1 is defined as the minimum observable difference that humans can perceive.

While the present invention has been described in accordance with preferred compositions and embodiments, it is to be understood that certain substitutions and alterations may be made thereto without departing from the spirit and scope of the following claims.

1. A writing paper with reading or writing lines, comprising:
a background area having a first color tone;
a plurality of reading or writing lines being disposed at regular intervals in the background area, the reading or writing lines having a second color tone, the second color tone being lighter than the first color tone of the background area; the reading or writing lines having a width in a range of 0.1-1.5 millimeter, and
the reading or writing lines and the background area having a color difference, defined as delta E (CIE)-Lab space, being in an interval of 2-10.

2. The writing paper according to claim 1 wherein delta E is in an interval around 6.

3. The writing paper according to claim 1 wherein the reading or writing lines have a width ranging from 0.3-0.4 millimeter.

4. The writing paper according to claim 3 wherein the reading or writing lines have a width that is about 0.35 millimeters.

5. The writing paper according to claim 3 wherein the reading or writing lines and white have a color difference, defined as delta E (CIE)-Lab space, being in an interval of 0-2.
